(19) United States
(12) Patent Application Publication
(10) Pub. No.: US 2014/0301455 A1
(43) Pub. Date: Oct. 9, 2014

(54) ENCODING/DECODING DEVICE AND METHOD USING VIRTUAL VIEW SYNTHESIS AND PREDICTION

(71) Applicants: Jin Young Lee, Yongin-si (KR); Jae Joon Lee, Yongin-si (KR); Joo Hyun Min, Seoul (KR)

(72) Inventors: Jin Young Lee, Yongin-si (KR); Jae Joon Lee, Yongin-si (KR); Joo Hyun Min, Seoul (KR)

(73) Assignee: SAMSUNG ELECTRONICS CO., LTD., Suwon-si (KR)

(21) Appl. No.: 14/241,320

(22) PCT Filed: Dec. 28, 2011
(86) PCT No.: PCT/KR2011/010204

§ 371 Date: Jun. 25, 2014

(30) Foreign Application Priority Data
Aug. 26, 2011 (KR) 10-2011-0085963

(51) Int. Cl. H04N 19/597; H04N 13/00; H04N 19/177; H04N 19/103; H04N 19/137

(52) U.S. Cl. CPC H04N 19/00769; H04N 19/00018; H04N 19/00145; H04N 19/00284; H04N 13/0048; H04N 13/0051; H04N 13/0011
USPC 375/240.12

(57) ABSTRACT

The present invention relates to an encoding/decoding device and method using view synthesis and prediction. The encoding device may synthesize images corresponding to the surrounding views of a current view, encode current blocks that are included in the images of the current view, and apply a skip mode and a residual signal encoding technique.

### TECHNICAL FIELD

Embodiments of the present invention relate to encoding/decoding devices and methods for encoding/decoding three-dimensional (3D) video, and more particularly, to a device and method for applying a result obtained by synthesizing images corresponding to views neighboring a current view to an encoding/decoding process.

### BACKGROUND ART

A stereoscopic image refers to a three-dimensional (3D) image that simultaneously provides shape information on a depth and space. In a stereo image, images of different views are provided to a left eye and a right eye, respectively, whereas a stereoscopic image is seen as if viewed from different directions every time an observer changes a point of view of the observer. Accordingly, to generate a stereoscopic image, images captured from various views are required.

Images captured from various views to generate a stereoscopic image may result in a huge quantity of data. Accordingly, considering a network infrastructure, a terrestrial bandwidth, and the like, it is almost infeasible to realize a stereoscopic image, despite compression being performed using an encoding device optimized for single-view video coding, for example, moving picture experts group phase (MPEG)-2, H.264/advanced video coding (AVC), high efficiency video coding (HEVC), and the like.

However, since images captured for each view of an observer are related to each other, a large quantity of redundant information may exist. Accordingly, when an encoding device optimized for a multiview image enabling removal of inter-view redundancy is used, less data may be transmitted.

Accordingly, a multiview image encoding device optimized to generate a stereoscopic image is required. In particular, there is a desire to develop a technology for efficiently reducing inter-temporal redundancy and inter-view redundancy.

### DISCLOSURE OF INVENTION

### Technical Solutions

In one general aspect, there is provided an encoding device including: a synthesis image generator to generate a synthesis image of a virtual view by synchronizing first images of neighboring views that are already encoded; and an image encoder to encode blocks included in a second image of a current view based on the synthesis image of the virtual view.

The encoding device may further include a mode selecting unit to select an optimum encoding mode from among defined encoding modes and encoding modes associated with synthesis prediction using the synthesis image.

The encoding device may further include a flag setting unit to set a flag “mb_skip_flag” of a skip mode to be located before a flag of a first encoding mode in a bitstream. The skip mode may be associated with a prediction scheme defined for the second image of the current view.

In another general aspect, there is provided an encoding device including: a synthesis image generator to generate a synthesis image of a virtual view by synchronizing first images of neighboring views that are already encoded; a mode selecting unit to select either a virtual view synthesis residual signal encoding mode or a virtual view synthesis skip mode associated with the synthesis image; and an image encoder to encode current blocks included in a second image of a current view based on a mode selected by the mode selecting unit.

In another general aspect, there is provided an encoding device including: a synthesis image generator to generate a synthesis image of a virtual view by synchronizing first images of neighboring views that are already encoded; a mode selecting unit to select a virtual view synthesis skip mode associated with the synthesis image; and an image encoder to encode current blocks included in a second image of a current view based on the virtual view synthesis skip mode.

In another general aspect, there is provided an encoding device including: a synthesis image generator to generate a synthesis image of a virtual view by synchronizing first images of neighboring views that are already encoded; a mode selecting unit to select a virtual view synthesis residual signal encoding mode associated with the synthesis image; and an image encoder to encode current blocks included in a second image of a current view based on the virtual view synthesis residual signal encoding mode.

In another general aspect, there is provided an encoding device including: a synthesis image generator to generate a synthesis image of a virtual view by synchronizing first images of neighboring views that are already encoded; a mode selecting unit to select an encoding mode with a best encoding performance from among a virtual view synthesis residual signal encoding mode, a virtual view synthesis skip mode associated with the synthesis image, and defined encoding modes; and an image encoder to encode current blocks included in a second image of a current view based on the encoding mode.

In another general aspect, there is provided a decoding device including: a synthesis image generator to generate a synthesis image of a virtual view by synchronizing first images of neighboring views that are already decoded; a mode determining unit to determine a decoding mode of a second image of a current view in a bitstream received from an encoding device; and an image decoder to decode current blocks included in the second image of the current view based on the synthesis image of the virtual view in the decoding mode.

The decoding device may further include a flag extractor to extract a flag of a first decoding mode located after a flag “mb_skip_flag” of a skip mode associated with a prediction scheme defined for the second image of the current view, in the bitstream.

In another general aspect, there is provided a decoding device including: a synthesis image generator to generate a synthesis image of a virtual view by synchronizing first images of neighboring views that are already decoded; a mode determining unit to determine a decoding mode that is a virtual view synthesis skip mode associated with the synthesis image from a bitstream; and an image decoder to decode current blocks included in a second image of a current view based on the decoding mode.

In another general aspect, there is provided a decoding device including: a synthesis image generator to generate a synthesis image of a virtual view by synchronizing first images of neighboring views that are already decoded; a mode determining unit to determine a decoding mode that is a virtual view synthesis residual signal decoding mode associated with the synthesis image from a bitstream; and an image decoder to decode current blocks included in a second image of a current view based on the decoding mode.

In another general aspect, there is provided an encoding method including: generating a synthesis image of a virtual view by synchronizing first images of neighboring views that are already encoded; and encoding current blocks included in a second image of a current view based on the synthesis image of the virtual view.

The encoding method may further include selecting an optimum encoding mode from among defined encoding modes and encoding modes associated with synthesis prediction using the synthesis image.

The encoding method may further include setting a flag “mb_skip_flag” of a skip mode to be located before a flag of a first encoding mode in a bitstream. The skip mode may be associated with a prediction scheme defined for the second image of the current view.

In another general aspect, there is provided an encoding method including: generating a synthesis image of a virtual view by synchronizing first images of neighboring views that are already encoded; selecting either a virtual view synthesis residual signal encoding mode or a virtual view synthesis skip mode associated with the synthesis image; and encoding current blocks included in a second image of a current view based on a selected mode.

In another general aspect, there is provided an encoding method including: generating a synthesis image of a virtual view by synchronizing first images of neighboring views that are already encoded; selecting a virtual view synthesis skip mode associated with the synthesis image; and encoding current blocks included in a second image of a current view based on the virtual view synthesis skip mode.

In another general aspect, there is provided an encoding method including: generating a synthesis image of a virtual view by synchronizing first images of neighboring views that are already encoded; selecting a virtual view synthesis residual signal encoding mode associated with the synthesis image; and encoding current blocks included in a second image of a current view based on the virtual view synthesis residual signal encoding mode.

In another general aspect, there is provided an encoding method including: generating a synthesis image of a virtual view by synchronizing first images of neighboring views that are already encoded; selecting an encoding mode with a best encoding performance from among a virtual view synthesis residual signal encoding mode, a virtual view synthesis skip mode associated with the synthesis image, and defined encoding modes; and encoding current blocks included in a second image of a current view based on the encoding mode.

In another general aspect, there is provided a decoding method including: generating a synthesis image of a virtual view by synchronizing first images of neighboring views that are already encoded; determining a decoding mode of a second image of a current view in a bitstream received from an encoding device; and decoding current blocks included in the second image of the current view based on the synthesis image of the virtual view in the decoding mode.

The decoding method may further include extracting a flag of a first decoding mode located after a flag of a skip mode associated with a prediction scheme defined for the second image of the current view, in the bitstream.

### Effects of the Invention

According to embodiments of the present invention, a synthesis image of a virtual view may be generated by synchronizing images of neighboring views, and blocks of a current view may be encoded based on the synthesis image and accordingly, inter-view redundancy may be removed. Thus, it is possible to enhance an encoding efficiency.

### BRIEF DESCRIPTION OF DRAWINGS

FIG. 1 is a diagram illustrating an operation of each of an encoding device and a decoding device according to an embodiment of the present invention.

FIG. 2 is a diagram illustrating a configuration of an encoding device according to an embodiment of the present invention.

FIG. 3 is a diagram illustrating a configuration of a decoding device according to an embodiment of the present invention.

FIG. 4 is a diagram illustrating a structure of multiview video according to an embodiment of the present invention.

FIG. 5 is a diagram illustrating an encoding system to which an encoding device is applied according to an embodiment of the present invention.

FIG. 6 is a diagram illustrating a decoding system to which a decoding device is applied according to an embodiment of the present invention.

FIG. 7 is a diagram illustrating a virtual view synthesis scheme according to an embodiment of the present invention.

FIG. 8 is a diagram illustrating a skip mode of a virtual view synthesis prediction scheme according to an embodiment of the present invention.

FIG. 9 is a diagram illustrating a residual signal encoding mode of a virtual view synthesis prediction scheme according to an embodiment of the present invention.

FIG. 10 is a diagram illustrating a flag position of a skip mode of a virtual view synthesis prediction scheme according to an embodiment of the present invention.

### BEST MODE FOR CARRYING OUT THE INVENTION

The following detailed description is provided in order to explain the example embodiments by referring to the figures.

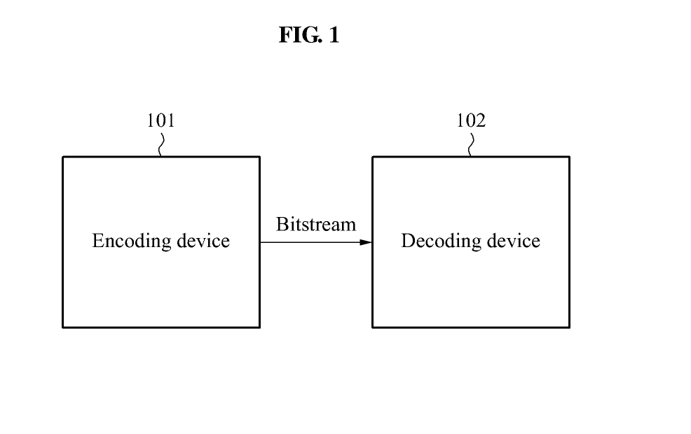

FIG. 1 is a diagram illustrating an operation of each of an encoding device and a decoding device according to an embodiment of the present invention.

An encoding device 101 may encode three-dimensional (3D) video, and may transmit encoded data in the form of a bitstream to a decoding device 102. When the 3D video is encoded, the encoding device 101 may enhance an encoding efficiency by maximally removing inter-image redundancy.

To remove the inter-image redundancy, an intra prediction scheme, an inter prediction scheme, and inter-view prediction scheme may be used. Additionally, to predict a block, various encoding modes, for example a skip mode, a 2N×2N mode, an N×N mode, a 2N×N mode, an N×2N mode, and an intra mode, may be used. In the skip mode, a bit rate may be reduced compared to the other encoding modes, because block information is not encoded. Accordingly, when a larger number of blocks are encoded in the skip mode during encoding of an image, an encoding performance may be enhanced.

According to embodiments of the present invention, in addition to the defined skip mode, a virtual view synthesis skip mode based on a synthesis image of a virtual view may be defined and accordingly, a probability that a larger number of blocks forming a current image are to be encoded in the skip mode may be increased. The encoding device 101 may generate a synthesis image of a virtual view by synthesizing images of neighboring views that are already encoded, and may encode an image of a current view based on the synthesis image.

In the following description, an image of a current view that is to be encoded by an encoding device may be defined as a “first image,” and each of images of neighboring views that are already encoded may be defined as a “second image.” Additionally, an image generated by synthesizing images of neighboring views may be defined as a “synthesis image.” The synthesis image may represent the same current view as the first image.

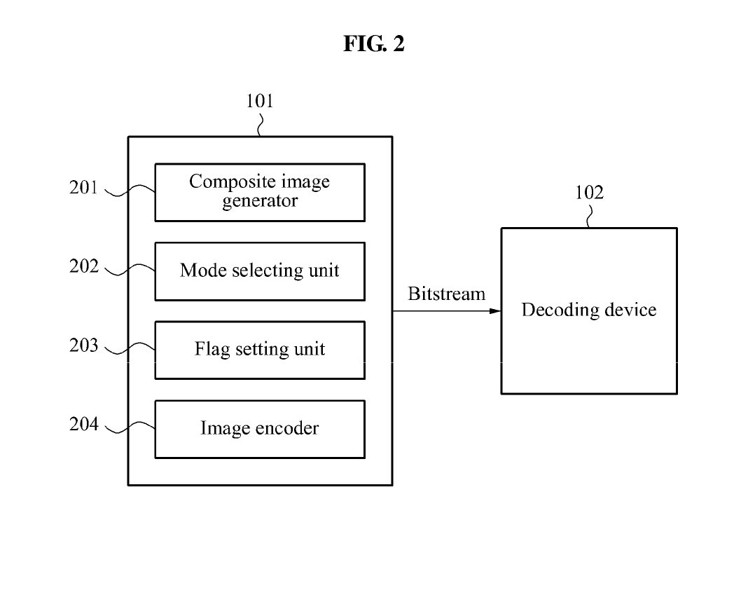

FIG. 2 is a diagram illustrating a configuration of an encoding device according to an embodiment of the present invention.

Referring to FIG. 2, the encoding device 101 may include a synthesis image generator 201, a mode selecting unit 202, a flag setting unit 203, and an image encoder 204.

The synthesis image generator 201 may generate a synthesis image of a virtual view by synthesizing first images of neighboring views that are already encoded. The neighboring views may refer to views corresponding to images neighboring a second image of a current view that is to be encoded. The virtual view may refer to the same view as a view corresponding to the second image.

The mode selecting unit 202 may select an optimum encoding mode from among encoding modes associated with synthesis prediction using the synthesis image and encoding modes that are defined.

In an example, the mode selecting unit 202 may determine a first encoding mode to search for a zero vector block located in the same location as a current block to be encoded in the synthesis image of the virtual view, and to replace the current block with the zero vector block. The first encoding mode may be defined as a virtual view synthesis skip mode.

In another example, the mode selecting unit 202 may determine a second encoding mode to search for a zero vector block located in the same location as a current block to be encoded in the synthesis image of the virtual view, and to encode a residual signal based on a prediction block that is most similar to the current block with respect to the zero vector block and based on a virtual synthesis vector indicating the prediction block. The second encoding mode may be defined as a virtual view synthesis residual signal encoding mode.

In still another example, the mode selecting unit 202 may select an encoding mode with a best encoding result from among the first encoding mode, and defined third encoding modes, or may select an encoding mode with a best encoding result from among the second encoding mode and the defined third encoding modes.

In an example, the third encoding modes may include a skip mode, an inter 2N×2N mode, an inter 2N×N mode, an inter N×2N mode, an inter N×N mode, an intra 2N×2N mode, an intra N×N mode, and the like. In another example, the third encoding modes may include a skip mode, an inter mode, and an intra mode.

Additionally, the mode selecting unit 202 may select an encoding mode from among the first encoding mode, the second encoding mode, and the defined third encoding modes, to encode the current block. For example, the mode selecting unit 202 may select an encoding mode with a best encoding performance, based on a result of encoding in the first encoding mode, a result of encoding in the second encoding mode, and results of encoding in the third encoding modes. The encoding mode with the best encoding performance may refer to an encoding mode with a minimum cost function.

The flag setting unit 203 may set a flag “mb_skip_flag” of a skip mode to be located before a flag of the first encoding mode in a bitstream. The skip mode may be associated with a prediction scheme that is defined for the second image of the current view.

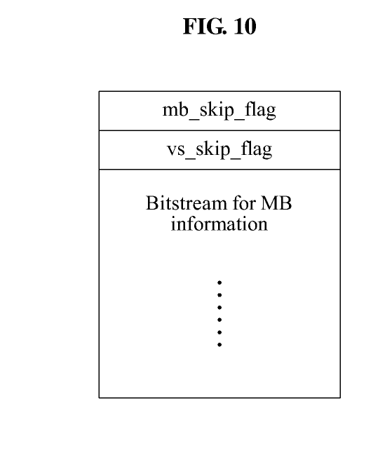

The skip mode may be different from a virtual view synthesis skip mode according to an embodiment of the present invention. A method of setting a flag will be further described with reference to FIG. 10.

The image encoder 204 may encode a current block included in the second image of the current view, based on an encoding mode. For example, when the skip mode associated with the defined prediction scheme is determined as an encoding mode of the current block, an encoding mode associated with synthesis prediction may be selectively applied.

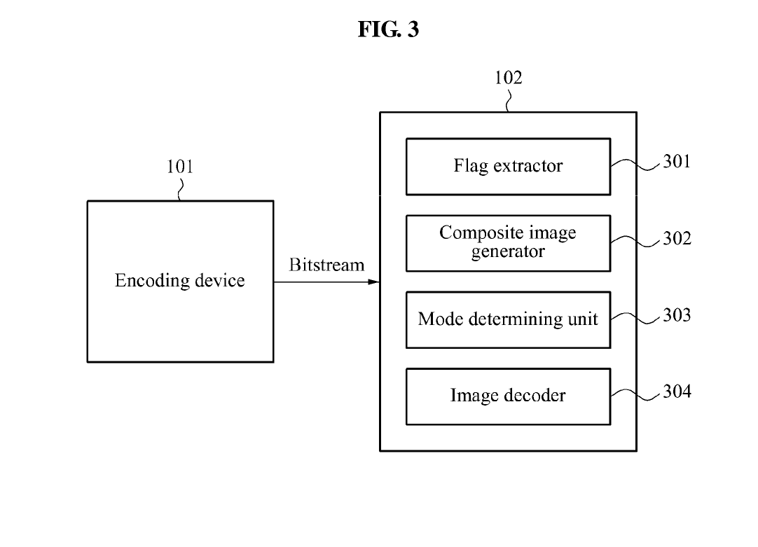

FIG. 3 is a diagram illustrating a configuration of a decoding device according to an embodiment of the present invention.

Referring to FIG. 3, the decoding device 102 may include a flag extractor 301, a synthesis image generator 302, a mode determining unit 303, and an image decoder 304. The flag extractor 301 may extract a flag of a first decoding mode that is located after a flag of a skip mode associated with a prediction scheme defined for the second image of the current view, from a bitstream received from the encoding device 101. The first decoding mode will be further described.

The synthesis image generator 302 may generate a synthesis image of a virtual view by synthesizing first images of neighboring views that are already decoded. The neighboring views may refer to views corresponding to images neighboring the second image of the current view that is to be decoded. Additionally, the virtual view may refer to the same view as a view corresponding to the second image that is to be decoded.

The mode determining unit 303 may determine a decoding mode of the second image of the current view that is encoded, in the bitstream received from the encoding device 101. The decoding device 102 may extract the decoding mode of the second image included in the bitstream.

In an example, the mode determining unit 303 may determine, from the bitstream, a first decoding mode to search for a zero vector block located in the same location as a current block to be decoded in the synthesis image of the virtual view, and to replace the current block with the zero vector block. In this example, the first decoding mode may be defined as a virtual view synthesis skip mode.

In another example, the mode determining unit 303 may determine, from the bitstream, a second decoding mode to search for a zero vector block located in the same location as a current block to be decoded in the synthesis image of the virtual view, and to decode a residual signal based on a decoded virtual synthesis vector indicating a prediction block that is most similar to the current block to be decoded among neighboring blocks with respect to the zero vector block. In this example, the second decoding mode may be defined as a virtual view synthesis residual signal decoding mode.

According to an embodiment of the present invention, a decoding mode of a current block that is included in the second image of the current view and that is to be decoded may correspond to an encoding mode transmitted through a bitstream.

The image decoder 304 may decode the current block included in the second image of the current view, based on the synthesis image of the virtual view in a decoding mode.

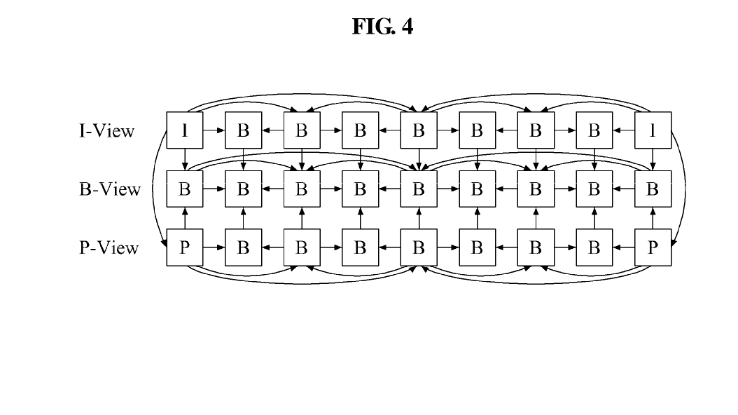

FIG. 4 is a diagram illustrating a structure of multiview video according to an embodiment of the present invention.

FIG. 4 illustrates a multiview video coding (MVC) scheme that encodes input images of three views, for example, a left view, a center view, and a right view, using group of picture (GOP) of “8.” To encode a multiview image, a hierarchical B picture may be basically applied in a temporal axis and a view axis. Therefore, inter-image redundancy may be reduced.

Based on the structure of the multiview video of FIG. 4, a multiview video encoding device 101 may encode images corresponding to the three views by sequentially encoding a left image of an I-view, a right image of a P-view, and a center image of a B-view.

The left image may be encoded by searching for a similar region from previous images through motion estimation and by removing temporal redundancy. Additionally, the right image may be encoded using the already encoded left image as a reference image and accordingly, the right image may be encoded by removing temporal redundancy based on motion estimation and inter-view redundancy based on disparity estimation. The center image may be encoded using both the left image and the right image that are already encoded as reference images and accordingly, inter-view redundancy may be removed through bidirectional disparity estimation.

Referring to FIG. 4, in the MVC scheme, an “I-view” may indicate an image, for example the left image, encoded without using a reference image of another view. A “P-view” may indicate an image, for example the right image, encoded by predicting a reference image of another view in one direction. Additionally, “B-view” may indicate an image, for example the center image, encoded by predicting reference images of the left view and the right view in both directions.

A frame of the MVC may be classified into six groups based on a prediction structure. The six groups may include an I-view anchor frame for intra coding, an I-view non-anchor frame for inter coding between temporal axes, a P-view anchor frame for unidirectional inter coding between views, a P-view non-anchor frame for unidirectional inter coding between views and bidirectional inter coding between time axes, a B-view anchor frame for bidirectional inter coding between views, and a B-view non-anchor frame for bidirectional inter coding between views and bidirectional inter coding between temporal axes.

According to embodiments of the present invention, the encoding apparatus 101 may generate a synthesis image of a virtual view by synthesizing first images of neighboring views, that is, a left view and a right view of a current view, and may encode a second image of the current view based on the synthesis image. The first images of the neighboring views required for synthesis may refer to already encoded images. For example, the encoding apparatus 101 may encode a P-view by synthesizing the already encoded I-view. In another example, the encoding apparatus 101 may encode a B-view by synthesizing the already encoded I-view image and P-view image. Therefore, the encoding apparatus 101 may encode a specific image by synthesizing neighboring images that are already encoded.

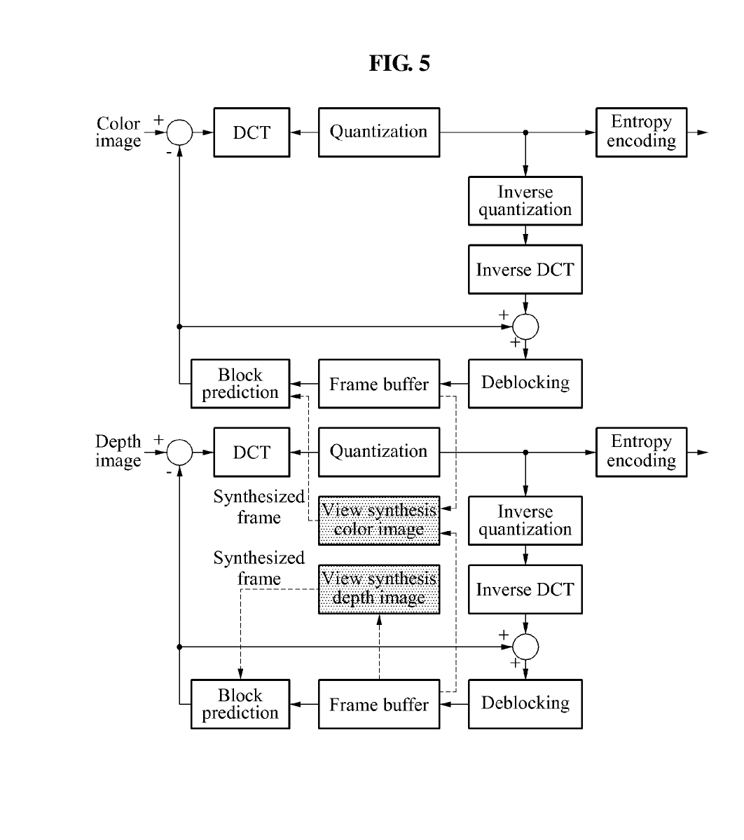

FIG. 5 is a diagram illustrating an encoding system to which an encoding device is applied according to an embodiment of the present invention.

Referring to FIG. 5, an additional structure for virtual view synthesis may be required to generate a synthesis image of a virtual view. In FIG. 5, to generate a synthesis image for a color image of a current view, the encoding device 101 may use a color image and a depth image of a neighboring view that are already encoded. Additionally, to generate a synthesis image for a depth image of the current view, the encoding device 101 may use a depth image of a neighboring view that is already encoded.

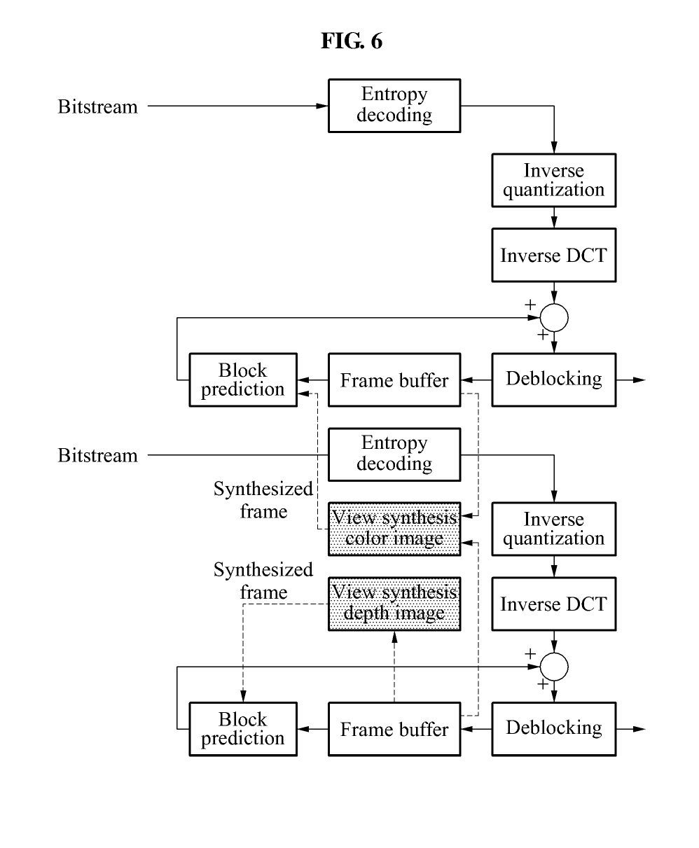

FIG. 6 is a diagram illustrating a decoding system to which a decoding device is applied according to an embodiment of the present invention.

The decoding device 102 of FIG. 6 may perform substantially the same operation as the encoding device 101 of FIG. 5 and accordingly, further description thereof will be omitted herein.

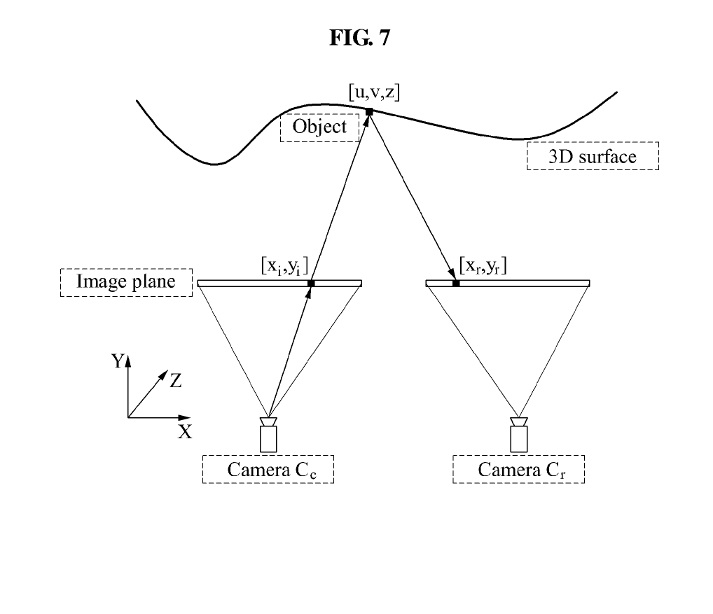

FIG. 7 is a diagram illustrating a virtual view synthesis scheme according to an embodiment of the present invention.

A synthesis image of a virtual view with respect to a color image and a depth image may be generated based on an already encoded color image and depth image, and camera parameter information. For example, the synthesis image of the virtual view with respect to the color image and the depth image may be generated based on Equations 1 through 3 shown below.

$${Z}_{r} ( x , y ) = \frac{1}{\frac{{D}_{r} ( x , y )}{255} ( \frac{1}{{Z}_{near}} - \frac{1}{{Z}_{far}} ) + \frac{1}{{Z}_{far}}} \qquad [ Equation 1 ]$$

D(x,y) denotes a pixel value at a pixel position (x,y) in a depth image. Znear and Zfar denote nearest depth information and farthest depth information, respectively.

The encoding device 101 may obtain actual depth information Z, and may reflect a pixel (x,y) of a current view to a world coordinate system (u,v,w) to synthesize an image r of a reference view into an image t of a target view. The pixel (x,y) may refer to a pixel of a color image when virtual view synthesis is performed on the color image, or a pixel of a depth image when virtual view synthesis is performed on the depth image.

[u,v,w]^{T}=Rᵣ·A⁻¹ᵣ·[x,y,1]^{T}·Zᵣ(x,y)+Tᵣ [Equation 2]

In Equation 2, A(c) denotes an intrinsic camera matrix, R(c) denotes a camera rotation matrix, T(c) denotes a camera translation matrix, and D denotes depth information.

Therefore, the encoding device 101 may reflect the world coordinate system (u,v,w) to a coordinate system (x′,y′,z′) of the reference image, as shown in Equation 3 below.

[x′,y′,z′]^{T}=Aₗ·R⁻¹ₗ·{[u,v,w]^{T}−Tₗ} [Equation 3]

Finally, a pixel corresponding to an image of the target view may be (x′/z′,y′/z′).

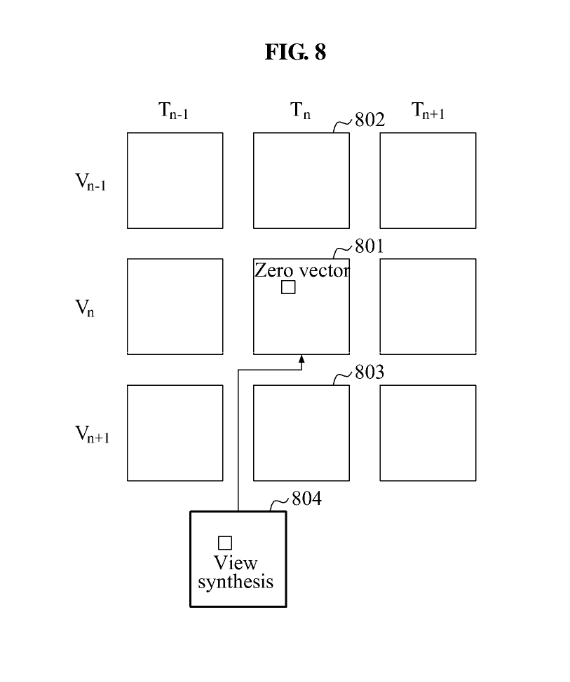

FIG. 8 is a diagram illustrating a skip mode of a virtual view synthesis prediction scheme according to an embodiment of the present invention.

Referring to FIG. 8, the encoding device 101 may generate a synthesis image 804 of a virtual view based on first images 802 and 803 of neighboring views of a second image 801 of a current view. The synthesis image 804 may have similar characteristics to the second image 801. The first images 802 and 803 may be already encoded before the second image 801 is encoded, and may be stored as reference images for the second image 801 in a frame buffer of FIG. 5.

The encoding device 101 may select a first encoding mode to search for a zero vector block located in the same location as a current block in the synthesis image 804 and to replace the current block with the zero vector block. Actually, in the first encoding mode, a current block included in the second image 801 may be replaced with the zero vector block included in the synthesis image 804, instead of being encoded. The first encoding mode may represent a virtual view synthesis skip mode.

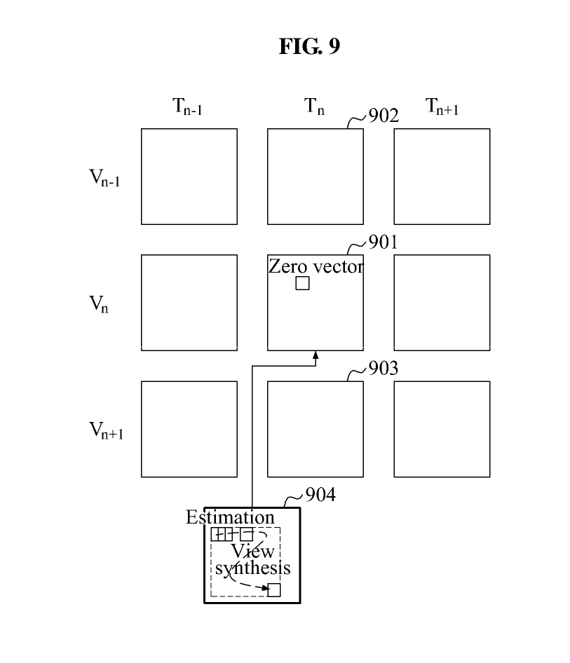

FIG. 9 is a diagram illustrating a residual signal encoding mode of a virtual view synthesis prediction scheme according to an embodiment of the present invention.

Referring to FIG. 9, the encoding device 101 may generate a synthesis image 904 of a virtual view based on first images 902 and 903 of neighboring views of a second image 901 of a current view. The synthesis image 904 may have similar characteristics as the second image 901. The first images 902 and 903 may be already encoded before the second image 901 is encoded, and may be stored as reference images for the second image 901 in the frame buffer of FIG. 5.

The encoding device 101 may select a second encoding mode to search for a zero vector block located in the same location as a current block in the synthesis image 904 and to encode a residual signal based on a prediction block that is most similar to the current block to be encoded with respect to the zero vector block, and based on a virtual synthesis vector indicating the prediction block.

For example, the encoding device 101 may search for a block that is most similar to the current block to be encoded, among blocks included in a predetermined region with respect to the zero vector block in the synthesis image 904. A block that is most similar to the zero vector block may be defined as a prediction block. In addition, the encoding device 101 may determine the virtual synthesis vector indicating the prediction block in the zero vector block. The encoding device 101 may encode a differential signal between the current block included in the second image 901 and the prediction block, together with the virtual synthesis vector corresponding to the prediction block. The second encoding mode may represent a virtual view synthesis residual signal encoding mode.

At least one of the virtual view synthesis skip mode and the virtual view synthesis residual signal encoding mode may be used along with an encoding mode that is defined.

FIG. 10 is a diagram illustrating a flag position of a skip mode of a virtual view synthesis prediction scheme according to an embodiment of the present invention.

As described above, the encoding device 101 may select an encoding mode of a current block included in a second image of a current view. To encode the current block, the encoding device 101 may select a single encoding mode from among the first encoding mode, the second encoding mode, and the defined third encoding modes.

The encoding device 101 may select an encoding mode with a best encoding performance, based on a result of encoding in the first encoding mode, a result of encoding in the second encoding mode, and results of encoding in the defined third encoding modes. The encoding mode with the best encoding performance may refer to an encoding mode with a minimum cost function.

The first encoding mode may refer to an encoding mode to search for a zero vector block located in the same location as a current block to be encoded in a synthesis image of a virtual view, and to replace the current block with the zero vector block. The first encoding mode may be defined as a virtual view synthesis skip mode.

The second encoding mode may refer to an encoding mode to search for a zero vector block located in the same location as a current block in the synthesis image of the virtual view, and to encode a residual signal, based on a prediction block that is most similar to a current block to be encoded with respect to the zero vector block, and based on a virtual synthesis vector indicating the prediction block. The second encoding mode may be defined as a virtual view synthesis residual signal encoding mode.

For example, when the first encoding mode is selected, the encoding device 101 may identify the first encoding mode using a bit flag, and may transfer the bit flag to the decoding device 102.

Referring to FIG. 10, an additional bit flag may be required to use a determined virtual synthesis view skip mode. According to an embodiment of the present invention, the encoding device 101 may enable a flag “vs_skip_flag” of the virtual view synthesis skip mode to be located after a flag “mb_skip_flag” of a skip mode that is defined.

In an example, when a skip mode of the defined third encoding mode is determined as an encoding mode of the current block in the second image of the current view, the encoding device 101 may set the flag “mb_skip_flag” to “1,” and may transmit the flag “mb_skip_flag” to the decoding device 102. In another example, when the first encoding mode, that is, the virtual view synthesis skip mode is determined as an encoding mode of the current block in the second image of the current view, the encoding device 101 may set the flags “mb_skip_flag” and “vs_skip_flag” to “0,” and “1,” respectively, and may transmit the flags “mb_skip_flag” and “vs_skip_flag” to the decoding device 102.

In still another example, when a mode other than the skip mode, that is, the defined third encoding mode and the virtual view synthesis skip mode, that is, the first encoding mode is determined as an encoding mode of the current block in the second image of the current view, the encoding device 101 may set both the flags “mb_skip_flag” and “vs skip_flag” to “0,” and may transmit the flags “mb_skip_flag” and “vs_skip_flag” to the decoding device 102.

Additionally, when the skip mode of the defined third encoding mode is determined as an optimum encoding mode of the current block in the second image of the current view, the encoding device 101 may not use a virtual view synthesis scheme according to an embodiment of the present invention.

The methods according to embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An encoding device, comprising:
a synthesis image generator to generate a synthesis image of a virtual view by synchronizing first images of neighboring views that are already encoded; and
an image encoder to encode current blocks included in a second image of a current view based on the synthesis image of the virtual view.

2. The encoding device of claim 1, further comprising:
a mode selecting unit to select an encoding mode of current blocks associated with synthesis prediction, based on the synthesis image of the virtual view,
wherein the image encoder encodes the current blocks in the second image of the current view based on the encoding mode.

3. The encoding device of claim 2, wherein the mode selecting unit determines a first encoding mode to search for a zero vector block located in the same location as a current block in the second image in the synthesis image of the virtual view, and to replace the current block with the zero vector block.

4. The encoding device of claim 2, wherein the mode selecting unit determines a second encoding mode to search for a zero vector block located in the same location as a current block in the synthesis image of the virtual view, and to encode a residual signal, based on a prediction block that is most similar to a current block that is included in the second image and is to be encoded with respect to the zero vector block, and based on a virtual synthesis vector indicating the prediction block.

5. The encoding device of claim 2, the mode selecting unit determines an encoding mode with a minimum cost function between a first encoding mode to replace the current block with a zero vector block and a second encoding mode to encode a residual signal based on a prediction block that is most similar to a current block to be encoded with respect to the zero vector block and based on a virtual synthesis vector indicating the prediction block.

6. The encoding device of one of claims 3 and 5, further comprising:
a flag setting unit to set a flag of a skip mode to be located before a flag of the first encoding mode in a bitstream, the skip mode being associated with a prediction scheme defined for the second image of the current view.

7. The encoding device of claim 2, wherein when a skip mode associated with a defined prediction scheme is determined as an encoding mode of the current block, the image encoder selectively applies an encoding mode associated with synthesis prediction.

8. An encoding device, comprising:
a synthesis image generator to generate a synthesis image of a virtual view by synchronizing first images of neighboring views that are already encoded;
a mode selecting unit to select either a virtual view synthesis residual signal encoding mode or a virtual view synthesis skip mode associated with the synthesis image; and
an image encoder to encode current blocks included in a second image of a current view based on a mode selected by the mode selecting unit.

9. An encoding device, comprising:
a synthesis image generator to generate a synthesis image of a virtual view by synchronizing first images of neighboring views that are already encoded;
a mode selecting unit to select a virtual view synthesis skip mode associated with the synthesis image; and
an image encoder to encode current blocks included in a second image of a current view based on the virtual view synthesis skip mode.

10. An encoding device, comprising:
a synthesis image generator to generate a synthesis image of a virtual view by synchronizing first images of neighboring views that are already encoded;
a mode selecting unit to select a virtual view synthesis residual signal encoding mode associated with the synthesis image; and
an image encoder to encode current blocks included in a second image of a current view based on the virtual view synthesis residual signal encoding mode.

11. An encoding device, comprising:
a synthesis image generator to generate a synthesis image of a virtual view by synchronizing first images of neighboring views that are already encoded;
a mode selecting unit to select an encoding mode with a best encoding performance from among a virtual view synthesis residual signal encoding mode, a virtual view synthesis skip mode associated with the synthesis image, and defined encoding modes; and
an image encoder to encode current blocks included in a second image of a current view based on the encoding mode.

12. A decoding device, comprising:
a synthesis image generator to generate a synthesis image of a virtual view by synchronizing first images of neighboring views that are already decoded;
a mode determining unit to determine a decoding mode of a second image of a current view in a bitstream received from an encoding device; and
an image decoder to decode current blocks included in the second image of the current view based on the synthesis image of the virtual view in the decoding mode.

13. The decoding device of claim 12, wherein the mode determining unit determines, from the bitstream, a first decoding mode to search for a zero vector block located in the same location as a current block in the synthesis image of the virtual view, and to replace the current block with the zero vector block.

14. The decoding device of claim 12, wherein the mode determining unit determines, from the bitstream, a second decoding mode to search for a zero vector block located in the same location as a current block in the synthesis image of the virtual view, and to decode a residual signal based on a decoded virtual synthesis vector indicating a prediction block that is most similar to the current block to be decoded among neighboring blocks with respect to the zero vector block.

15. The decoding device of claim 13, further comprising:
a flag extractor to extract a flag of the first decoding mode located after a flag of a skip mode associated with a prediction scheme defined for the second image of the current view, in the bitstream.

16. An encoding method, comprising:
generating a synthesis image of a virtual view by synchronizing first images of neighboring views that are already encoded; and
encoding current blocks included in a second image of a current view based on the synthesis image of the virtual view.

17. The encoding method of claim 16, further comprising:
selecting an encoding mode of current blocks associated with synthesis prediction, based on the synthesis image of the virtual view,
wherein the encoding comprises encoding the current blocks in the second image of the current view based on the encoding mode.

18. The encoding method of claim 17, wherein the selecting comprises determining a first encoding mode to search for a zero vector block located in the same location as the current block to be encoded in the synthesis image of the virtual view, and to replace the current block with the zero vector block.

19. The encoding method of claim 17, wherein the selecting comprises determining a second encoding mode to search for a zero vector block located in the same location as the current block to be encoded in the synthesis image of the virtual view, and to encode a residual signal, based on a prediction block that is most similar to the current block to be encoded with respect to the zero vector block, and based on a virtual synthesis vector indicating the prediction block.

20. The encoding method of claim 17, wherein the selecting comprises determining an encoding mode with a minimum cost function between a first encoding mode to replace the current block with a zero vector block and a second encoding mode to encode a residual signal based on a prediction block that is most similar to the current block to be encoded with respect to the zero vector block and based on a virtual synthesis vector indicating the prediction block.

21. The encoding method of one of claims 18 and 20, further comprising:
setting a flag of a skip mode to be located before a flag of the first encoding mode in a bitstream, the skip mode being associated with a prediction scheme defined for the second image of the current view.

22. The encoding method of claim 17, wherein the encoding comprises, when a skip mode associated with a defined prediction scheme is determined as an encoding mode of the current block, selectively applying an encoding mode associated with synthesis prediction.

23. An encoding method, comprising:
generating a synthesis image of a virtual view by synchronizing first images of neighboring views that are already encoded;
selecting either a virtual view synthesis residual signal encoding mode or a virtual view synthesis skip mode associated with the synthesis image; and
encoding current blocks included in a second image of a current view based on a selected mode.

24. An encoding method, comprising:
generating a synthesis image of a virtual view by synchronizing first images of neighboring views that are already encoded;
selecting a virtual view synthesis skip mode associated with the synthesis image; and
encoding current blocks included in a second image of a current view based on the virtual view synthesis skip mode.

25. An encoding method, comprising:
generating a synthesis image of a virtual view by synchronizing first images of neighboring views that are already encoded;
selecting a virtual view synthesis residual signal encoding mode associated with the synthesis image; and
encoding current blocks included in a second image of a current view based on the virtual view synthesis residual signal encoding mode.

26. An encoding method, comprising:
generating a synthesis image of a virtual view by synchronizing first images of neighboring views that are already encoded;
selecting an encoding mode with a best encoding performance from among a virtual view synthesis residual signal encoding mode, a virtual view synthesis skip mode associated with the synthesis image, and defined encoding modes; and
encoding current blocks included in a second image of a current view based on the encoding mode.

27. A decoding method, comprising:
generating a synthesis image of a virtual view by synchronizing first images of neighboring views that are already decoded;
determining a decoding mode of a second image of a current view in a bitstream received from an encoding device; and
decoding current blocks included in the second image of the current view based on the synthesis image of the virtual view in the decoding mode.

28. The decoding method of claim 27, wherein the determining comprises determining, from the bitstream, a first decoding mode to search for a zero vector block located in the same location as a current block to be decoded in the synthesis image of the virtual view, and to replace the current block with the zero vector block.

29. The decoding method of claim 27, wherein the determining comprises determining, from the bitstream, a second decoding mode to search for a zero vector block located in the same location as a current block to be decoded in the synthesis image of the virtual view, and to decode a residual signal based on a decoded virtual synthesis vector indicating a prediction block that is most similar to the current block to be decoded among neighboring blocks with respect to the zero vector block.

30. The decoding method of claim 27, further comprising:
extracting a flag of the first decoding mode located after a flag of a skip mode associated with a prediction scheme defined for the second image of the current view, in the bitstream.

31. A non-transitory computer readable recording medium storing a program to cause a computer to implement the method of one of claims 16 to 20 and 22 to 30.
